(19) United States
(12) Patent Application Publication
(10) Pub. No.: US 2006/0049098 A1
(43) Pub. Date: Mar. 9, 2006

(54) Filter cover with a rapid assembled connector used in water inlet and water outlet of the filter cover

(76) Inventor: Mao-Chang Lin, Taichung Hsien (TW)

Correspondence Address: Mao-Chang Lin, 235 Chung-Ho, Box 8-24, Taipei, TW

(21) Appl. No.: 10/936,380

(22) Filed: Sep. 9, 2004

(51) Int. Cl. B01D 35/28

(52) U.S. Cl. 210/443; 210/541; 285/30

(57) ABSTRACT

A filter cover with a rapid assembled connector used in a water inlet and a water outlet of the filter cover comprises two round tube; each having a washer at a first end thereof which serves to be inserted into a casing; at least one block being protruded from a periphery of the round tube; a buckling sheet being backwards extended at one end of each block; a second end of the round tube being used to be connected to other tubes; a casing having a water inlet and a water outlet; the water inlet having a first opening extending inwards into the casing; the water outlet having a second opening extending inwards into the casing; sizes of the first and second openings being slightly larger than the that of the block; the first opening having at least first hole; and the second opening having at least one second hole.

### FIELD OF THE INVENTION

The present invention relates to connectors, and particularly to a filter cover with a rapid assembled connector used in a water inlet and a water outlet of the filter cover.

### BACKGROUND OF THE INVENTION

A water filter mainly includes a cylinder and a cover which is screwed to the cylinder. Water flows into the filter from an inlet and out of the filter from an outlet. Each of the inlet and outlet has a connector. This structure is basic for the water filter with detachable filter material or undetachable filter material.

Referring to FIGS. 1 and 2, the water inlet 10 and outlet 11 of a filter cover 1 are formed with inner threads 100, 110, respectively. The connectors have outer threads with equal thread pitches to the inner threads 100, 110, respectively. Thereby the connectors can be screwed into the inlet 10 and the outlet 11 and another ends of the connectors are connected to the tubes.

However since the connections of the inlets and outlets with the connectors are performed by thread engagements. The inlet, outlet, and connectors must be formed with matched threads. Moreover, the thread engagement takes longer time to the workers. Furthermore, to have drain-proof effect, several layers of tapes enclose the outer threads of the connectors so as to increase the tightness of the threads. However this makes the operation become inconvenient.

### SUMMARY OF THE INVENTION

Accordingly, the primary object of the present invention is to provide a filter cover with a rapid assembled connector used in a water inlet and a water outlet of the filter cover, in that the connector can be installed to and detached from the filter cover rapidly with a convenient operation.

To achieve above objects, the present invention provides a filter cover with a rapid assembled connector used in a water inlet and a water outlet of the filter cover which comprises two round tube; each round tube having a washer at a first end thereof which serves to be inserted into a casing; at least one block being protruded from a periphery of the round tube; a buckling sheet being backwards extended at one end of each block; a second end of the round tube being used to be connected to other tubes; a casing having a water inlet and a water outlet; the water inlet having a first opening extending inwards into the casing; the water outlet having a second opening extending inwards into the casing; sizes of the first and second openings being slightly larger than the that of the block; the first opening having at least first hole; the second opening having at least one hole.

The various objects and advantages of the present invention will be more readily understood from the following detailed description when read in conjunction with the appended drawing.

### BRIEF DESCRIPTION OF THE DRAWINGS

FIG. 1 is an exploded perspective view of the prior art connectors and the filter cover.

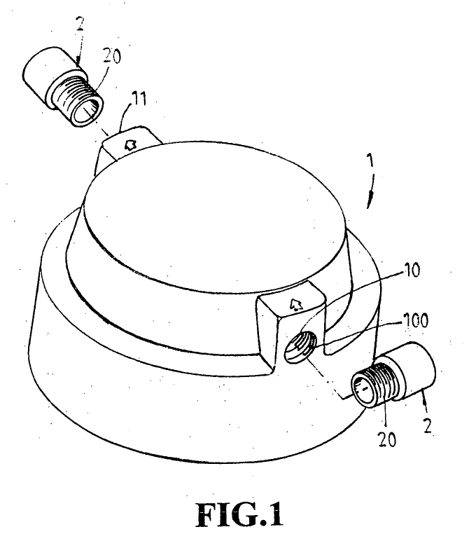

FIG. 2 is an assembled cross sectional view of FIG. 1.

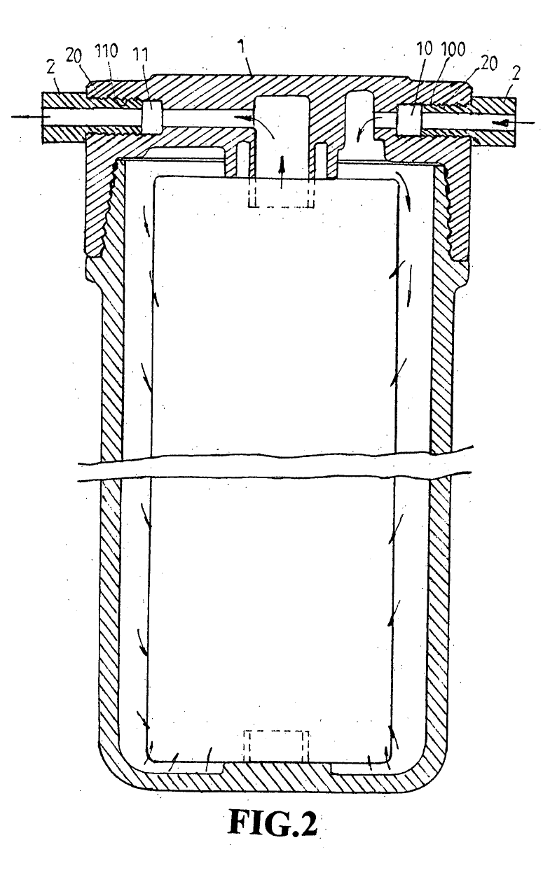

FIG. 3 is an exploded perspective view of the present invention.

FIG. 4 is an assembled cross sectional view of the present invention.

FIG. 5 is a structural schematic view of another embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

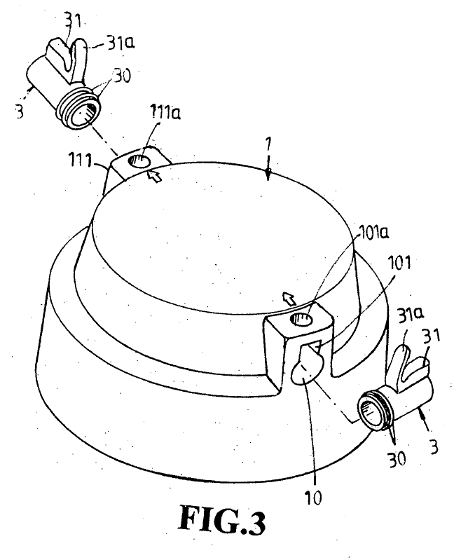

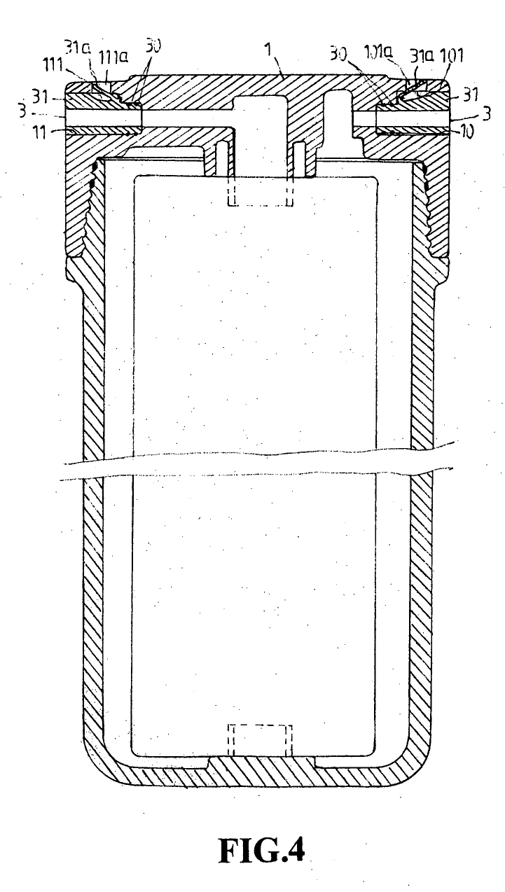

With reference to FIGS. 3 and 4, the connector of the present invention is illustrated. The present invention has the following elements.

Two round tubes 3 are included. Each round tube 3 has a washer 30 at a first end thereof. The first end serves to be inserted into a casing 1. At least one block 31 is protruded from a periphery of the round tube 3. A buckling sheet 31a is backwards extended at one end of each block 31. A second end of the round tube 3 is used to be connected to other tubes.

A casing 1 has a first water inlet 10 and a water outlet 11. The water inlet 10 has a first opening 101 extending inwards into the casing 1. The water outlet 11 has a second opening 111 extending inwards into the casing 1. Sizes of the first and second openings 101, 111 are slightly larger than the that of the block. The first opening 101 has at least first hole 101a. The second opening 111 has at least one hole 111a. The numbers of the first holes 101a and the second holes 111a are corresponding to that of the block 31. A size of each hole 111a, 111a exactly receives the buckling sheet 31a.

In assembly the block 31 is rapidly received into the first or second openings 101, 111 of the water inlet 101 and the water outlet 111. Thereby the buckling sheet 31a is buckled into the first or second holes 111a, 111a so that the round tube 3 is firmly secured to the water inlet 10 or the water outlet 11. Furthermore, the washer 30 in a front end of the round tube 3 cause that the round tube 3 is tightly engaged to the first or second openings.

In FIGS. 3 and 4, it is illustrated that the number of the block 31 protruded from each of the round tube 3 is one, in this case, the number of the hole in each opening is one.

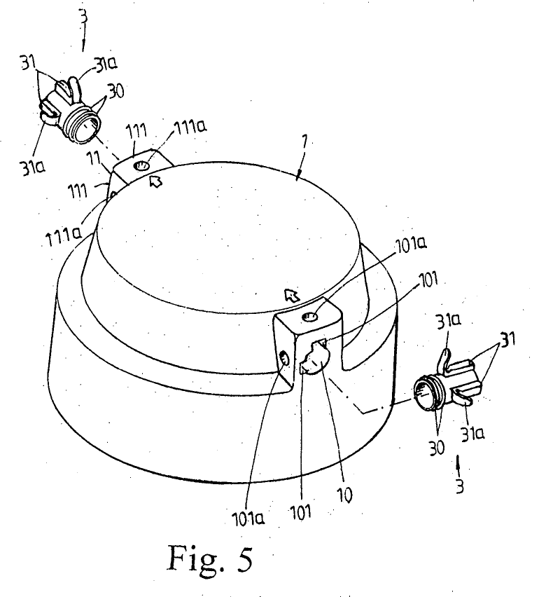

In FIG. 5, another embodiment is illustrated, where the number of the block 31 protruded from each of the round tube 3 is two. In this case, the number of holes in each opening is also 2. The two blocks 31 are guided into the holes of each opening so that the round tube 3 are firmly secured into the openings.

Referring to FIG. 4, if it is desired to take out the rapid assembled connector from the opening, it is only necessary to press the buckling sheet 31a from the holes 101a or 111a. Then the round tube 3 can be withdrawn so as to detach the connector for reuse.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A filter cover with a rapid assembled connector used in a water inlet and a water outlet of the filter cover comprising:
two round tubes; each round tube having a washer at a first end thereof; the first end serving to be inserted into a casing; at least one block being protruded from a periphery of the round tube; a buckling sheet being backwards extended at one end of each block; a second end of the round tube being used to be connected to other tubes;
a casing having a water inlet and a water outlet; the water inlet having a first opening extending inwards into the casing; the water outlet having a second opening extending inwards into the casing; sizes of the first and second openings being slightly larger than the that of the block; the first opening having at least one first hole; the second opening having at least one second hole; the numbers of the first holes and the second holes being corresponding to that of the block of each round tube; a size of each of the first and second hole exactly receiving the buckling sheet;
wherein in assembly the block is rapidly received into the first or second openings of the water inlet and the water outlet; thereby the buckling sheet is buckled into the first or second holes so that the round tube is firmly secured to the water inlet or the water outlet; the washer in a front end of the round tube cause that the round tube is tightly engaged to the first or second openings.

2. The filter cover with a rapid assembled connector used in a water inlet and a water outlet of the filter cover as claimed in claim 1, wherein the number of the block protruded from each of the round tube is one, and the number of the hole in each opening is also one.

3. The filter cover with a rapid assembled connector used in a water inlet and a water outlet of the filter cover as claimed in claim 1, wherein the number of the block protruded from each of the round tube is two; and the number of the holes in each opening is two.

4. The filter cover with a rapid assembled connector used in a water inlet and a water outlet of the filter cover as claimed in claim 1, wherein when the buckling sheet is pressed from the holes, the round tube can be withdrawn so as to detach the connector for reuse.
